(19) United States
(12) Patent Application Publication
(10) Pub. No.: US 2023/0186215 A1
(43) Pub. Date: Jun. 15, 2023

(54) VEHICLE RENTAL METHOD BASED ON A SAFE DRIVING GRADE AND A SERVER USING THE SAME

(71) Applicants: HYUNDAI MOTOR COMPANY, Seoul (KR); KIA CORPORATION, Seoul (KR)

(72) Inventor: Nahyeon Pak, Anyang-si (KR)

(73) Assignees: HYUNDAI MOTOR COMPANY, Seoul (KR); KIA CORPORATION, Seoul (KR)

(21) Appl. No.: 17/739,392

(22) Filed: May 9, 2022

(30) Foreign Application Priority Data
Dec. 15, 2021 (KR) 10-2021-0180058

(51) Int. Cl. G06Q 10/06; G06Q 30/06

(52) U.S. Cl. CPC G06Q 10/0635; G06Q 30/0645

(57) ABSTRACT

A rental management server includes: a communication portion that receives a rental reservation request for a vehicle from a user terminal, and receives integrated data about a user from an external server. The rental management server also includes a controller that generates information on the user's driving propensity by analyzing the integrated data, derives a safe driving score for the user based on information about the driving propensity of the user, determines a safe driving grade for the user based on the safe driving score, and adds benefits or restrictions to rental services provided to the user according to the safe driving grade. Further, the rental management server includes a storage portion that stores booker information included in the reservation request and the integrated data in a database. The information about the user's driving propensity includes pattern information generated by analyzing driving pattern data, and an accident risk .

### CROSS-REFERENCE TO RELATED APPLICATION

This application claims priority to and the benefit of Korean Patent Application No. 10-2021-0180058, filed in the Korean Intellectual Property Office on Dec. 15, 2021, the entire contents of which are incorporated herein by reference.

### TECHNICAL FIELD

The present disclosure relates to a vehicle rental method based on a safe driving grade, and a server using the same.

### BACKGROUND

Recently, the supply and demand for shared vehicle services has been increasing. In addition, due to the proliferation of non-face-to-face services, the number of operators providing shared vehicle services and that provide non-face-to-face services, from membership registration to vehicle rental, have also been increasing.

In providing non-face-to-face services, problems may arise when a vehicle driver and vehicle rental entity are different, and the operator cannot distinguish users with a high risk of accidents. As a result, a problem may arise in which the operator has to bear the risk of users with a high risk of accidents.

The above information disclosed in this Background section is only to enhance the understanding of the background of the present disclosure. Therefore it may contain information that does not form the prior art that is already known to a person having ordinary skill in the art.

### SUMMARY

The present disclosure provides a vehicle rental method that collects information about users who want to use vehicle rental services. The vehicle rental method enables driver verification to identify vehicle drivers and vehicle rental entities in order to reduce the accident rate, and a server using the same.

In one form of the present disclosure, a rental management server includes: a communication portion that receives a rental reservation request for a vehicle from a user terminal, and receives integrated data about a user. The integrated data about a user includes at least three of driving pattern data, accident history data, traffic law violation data, driver's license data, member authority data, and profile data from an external server. The rental management server further includes a controller that generates information on the user's driving propensity by analyzing the integrated data, derives a safe driving score for the user based on information about the driving propensity of the user, determines a safe driving grade for the user based on the safe driving score, and adds benefits or restrictions to rental services provided to the user according to the safe driving grade. The rental management server also includes a storage portion that stores booker information included in the reservation request and the integrated data in a database. Further, the information about the user's driving propensity includes pattern information generated by analyzing the driving pattern data, and an accident risk generated by analyzing the accident history data.

The controller may derive an extreme driving score of the user according to a frequency of occurrence of a driving pattern type based on the pattern information. Further, an accident risk score of the user is derived according to an accident type.

The controller may derive a safe driving score for the user based on the extreme driving score and the accident risk score.

The controller may impose a maximum speed limit on a rental service provided to the user when the safe driving grade is a risk grade (e.g., a dangerous grade).

The controller may add a service usage fee discount to the rental service provided to the user when the safe driving grade is a safe grade (e.g., a risk-free grade).

The controller may transmit a door control signal to unlock the door of the vehicle to the user terminal when: the booker and the user match, the user is an adult, the user's driver's license status included in the driving license data is valid, and a distance between the position of the vehicle and the user is within a predetermined distance.

After transmitting the door control signal, when the controller is able to impose driving control authority with respect to the vehicle to the user terminal based on a face image (e.g., facial recognition) and a sobriety test result of the user, the controller may transmit a driving control signal to unlock the starting lock of the vehicle to the user terminal.

A vehicle rental method, according to another aspect of the present disclosure, includes receiving a rental reservation request for a vehicle from a user terminal by a rental management server, and receiving integrated data about a user from an external server by the rental management server. The integrated data includes at least three of driving pattern data, accident history data, traffic law violation data, driver's license data, member authority data, and profile data. The vehicle rental method also includes generating the user's driving propensity by analyzing the integrated data by the rental management server, and determining a safe driving score of the user and a safe driving grade of the user by analyzing information on the driving propensity by the rental management server. The information on the driving propensity includes pattern information generated by analyzing the driving pattern data, and an accident risk generated by analyzing the traffic law violation data. The vehicle rental method further includes providing a rental service to which benefits or restrictions are added to the user according to the safe driving grade by the rental management server.

The vehicle rental method may further include, when the safe driving grade is a risk grade, imposing a maximum speed limit on the rental service provided to the user terminal by the rental management server. The vehicle rental method may also include, when the safe driving grade is a safe grade, adding a service usage fee discount to the rental service provided to the user terminal by the rental management server.

The vehicle rental method may further include verifying a driver's authority with respect to the user terminal by the rental management server.

The vehicle rental method may further include transmitting a door control signal to unlock a door of the vehicle to the user terminal by the rental management server when: the booker included in the reservation request matches the user, the user is an adult, the user's driver's license status included in the driving license data is valid, and a distance between the position of the vehicle and the user is within a predetermined distance.

The vehicle rental method may further include transmitting a signal indicating that the service is unavailable to the user terminal by the rental management server when: the booker included in the reservation request does not match the user, the user is not an adult, the driver's license status of the user included in the driving license data is not a valid license status, or the distance between the vehicle and the user exceeds the predetermined distance.

The vehicle rental method may further include, after transmitting the door control signal, transmitting a driving control signal to unlock the starting lock of the vehicle to the user terminal by the rental management server when driving control authority with respect to the vehicle is imposed to the user terminal.

The vehicle rental method may further include transmitting the driving control signal to the user terminal by the rental management server when the user corresponds to a registered user based on a face image of the user (e.g., facial recognition), and when the user is determined to be sober based on a sobriety test result of the user.

In order to reduce the incidence of accidents, information on users who want to use vehicle rental services are collected, and driver verification is carried out to identify vehicle drivers and vehicle rental entities. Thus, it is possible to provide safe and verified vehicle rental services, and improve user satisfaction of vehicle rental services.

### BRIEF DESCRIPTION OF THE DRAWINGS

In order that the disclosure may be well understood, there will now be described various forms thereof, given by way of example, reference being made to the accompanying drawings, in which:

FIG. 1 is a block diagram of a configuration of a vehicle rental system according to an embodiment;

FIG. 2 is a block diagram of a configuration of the server of FIG. 1;

FIG. 3 is a flowchart of a vehicle rental method according to an embodiment;

FIG. 4 is a detailed flowchart of step S5 and step S6 in FIG. 3; and

FIG. 5 is a detailed flowchart of step S7 in FIG. 3.

The drawings described herein are for illustration purposes only and are not intended to limit the scope of the present disclosure in any way.

### DETAILED DESCRIPTION

Hereinafter, referring to the drawings, embodiments disclosed in the present specification are described in detail, but the same or similar constituent elements are given the same and similar reference numerals, and overlapping descriptions thereof are omitted. The suffixes “module” and/or “-portion” for the constituent element used in the following description are given or mixed in consideration to only ease the writing of the specification, and do not have distinct meanings or roles by themselves. In addition, in describing the embodiment disclosed in the present specification, when it is determined that a detailed description of a related known technology may obscure the gist of the embodiment disclosed in this specification, the detailed description is omitted. In addition, the attached drawings are only to ease understanding of the embodiment disclosed in the present specification, and the technical idea disclosed in this specification is not limited by the attached drawings. All changes included in the spirit and technical range of the present disclosure should be understood to include equivalents or substitutes.

Terms including ordinal numbers such as first, second, and the like may be used to describe various configurations elements, but the constituent elements are not limited by the terms. The terms are used only for the purpose of distinguishing one constituent element from another constituent element.

In the present application, terms such as “comprise” or “have” are intended to designate that a feature, number, step, operation, constituent element, part, or combination thereof described in the specification exists, and it should be understood as not precluding the possibility of the presence or addition of one or more other features, numbers, steps, actions, constituent elements, parts, or combinations thereof.

Among the configurations, according to an embodiment, in the configuration for controlling another configuration in a specific control condition, a program implemented as a set of instruction words specifying the control algorithm desired to control the other configuration may be installed. According to the installed program, the control configuration may generate output data by processing input data and stored data. The control configuration may include non-volatile memory to store programs and memory to store data.

When a component, device, element, apparatus, or the like of the present disclosure is described as having a purpose or performing an operation, function, or the like, the component, device, apparatus, or element should be considered herein as being “configured to” meet that purpose or to perform that operation or function.

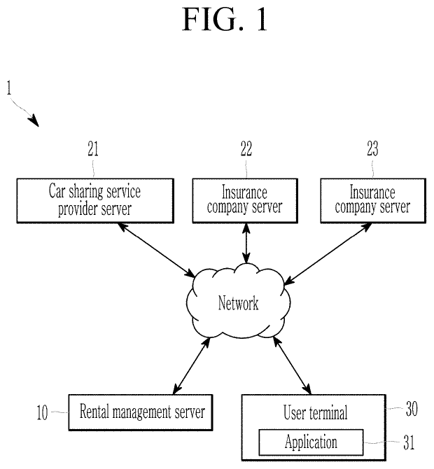

FIG. 1 is a block diagram of a configuration of a vehicle rental system according to an embodiment.

The vehicle rental system 1 may include a rental management server 10, a car-sharing service provider server 21, an insurance company server 22, an industrial complex server 23, and a user terminal 30.

External servers capable of transmitting and receiving information desired by the rental management server 10 may include the car-sharing service provider server 21, the insurance company server 22, and the industrial complex server 23. Information transmitting and receiving between the rental management server 10, the car-sharing service provider server 21, the insurance company server 22, the industrial complex server 23, and the user terminal 30 may be implemented by various communication methods through wired and wireless networks. The service provided by the vehicle rental system 1 to the user terminal 30 who wants to use the vehicle is hereinafter referred to as vehicle rental service. Here, the vehicle may mean a shared vehicle, such as a rental vehicle. The user of the user terminal 30 is hereinafter referred to as a user.

In FIG. 1, one user terminal is illustrated, but the present disclosure is not limited thereto, and the vehicle rental system 1 may include at least one user terminal.

The rental management server 10 receives integrated data on the user from the car-sharing service provider server 21, the insurance company server 22, and the industrial complex server 23. The rental management server: generates information about the user's driving propensity by analyzing the collected integrated data, calculates a safe driving score for the user based on information about the user's driving propensity, and determines a safe driving grade based on the safe driving score. The integrated data may include driving pattern data, accident history data, law violation data, driver's license data, member authority data, and profile data. Alternatively, the integrated data may include at least three of driving pattern data, accident history data, law violation data, driving license data, member authority data, and profile data. Depending on the safe driving grade, benefits or restrictions may be added to the rental service provided to users.

The driving pattern data may include a driving pattern type, an occurrence frequency for each driving pattern type, an occurrence time period of the driving pattern type, and an occurrence road type of the driving pattern type. The driving pattern type may be speeding, not securing a safe distance (e.g., not keeping a safe distance from another driver), sudden acceleration, rapid deceleration, sudden stop, sudden start, and the like.

The accident history data may include an accident type and frequency of occurrence by the accident type, a cause of the accident, and an accident date (including an accident time zone). The accident type may include a vehicle-to-person accident, a vehicle-to-vehicle accident, and a vehicle-only accident (e.g., vehicle-independent accident). The vehicle-to-person accident may include accidents while walking, roadway accidents, road edge accidents, and sidewalk accidents. The vehicle-to-vehicle accident may include head-on collisions, side-angled collisions, collisions, and the like. The vehicle-independent accident may include workpiece collision accidents, off-road accidents, and overturning/overturning accidents.

The law violation data may include traffic law violation types, frequency of occurrence for each traffic law violation type, and traffic law violation date (including traffic law violation time zone).

The driver's license data may include basic information about a license, such as a license number, a license acquisition date, and a license status. The license status may be a valid license, an expired license, and a suspended license. The member authority data may include a member status, a member status conversion date, and a reason for a member status conversion. The member status may be one of a valid member, a suspended member, a bad member, and an unsubscribed member.

The profile data may include name, gender, age, mobile phone number, driver's license information, customer identification ID, biometric authentication information, and service subscription date of a member.

The car-sharing service provider server 21 is an operating server of a car-sharing service provider that has previously provided a vehicle rental service to the user terminal 30. There may be one or more car-sharing service providers. The car-sharing service provider server 21 may retain driving pattern data, member authority data, and profile data for the user.

The insurance company server 22 is a server of an insurance company that provides vehicle insurance subscribed to by the user, and there may be more than one insurance company. The insurance company server 22 may retain accident history data for the user. The industrial complex server 23 may be a server of a corporation that collects and manages data related to a driver's license history, such as a Road Traffic Corporation. The industrial complex server 23 may retain law violation data for users, driver's license data, and the like.

The user may install an application 31 in the user terminal 30 to receive the vehicle rental service. Hereinafter, the transmitting and receiving of a signal, by the rental management server 10, to and from the user terminal 30 through the application 31, may be represented as transmitting and receiving a signal to and from the user terminal 30.

In FIG. 1, one car-sharing service provider server, one insurance company server, and one user terminal are shown, but this is for explaining an embodiment, and the disclosure is not limited thereto.

The rental management server 10 may receive data desired to provide a service from two or more car-sharing service provider servers and two or more insurance company servers.

In addition, each of the plurality of user terminals may request a service from the rental management server 10.

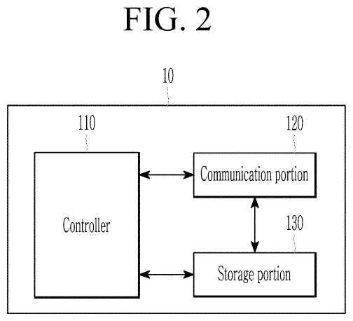

FIG. 2 is a block diagram of a configuration of the rental management server 10 of FIG. 1.

The rental management server 10 may include a controller 110, a communication portion 120 (e.g., communication unit), and a storage portion 130.

The controller 110 may: analyze the integrated data received through the communication portion 120, generate information about the user's driving propensity, derive a safe driving score and a safe driving grade for the user based on the information about the user's driving propensity, and provide a vehicle rental service according to the safe driving grade. The controller 110 may determine whether to transmit a door control signal or a driving control signal for the vehicle to the user terminal 30 based on a user's face image and a user's sobriety test result received through the communication portion 120. The door control signal may include a signal for instructing an unlocking of a door or a signal for instructing a locking of the door. The driving control signal may include a signal for releasing a starting lock of the vehicle or a signal indicating a starting lock.

The communication portion 120 may receive a reservation request for vehicle rental (hereinafter, a reservation request) from the user terminal 30. The reservation request may include information about a person who intends to operate the vehicle (i.e., booker information). The communication portion 120 is connected to the car-sharing service provider server 21, the insurance company server 22, the industrial complex server (e.g., the Road Traffic Authority) 23, and the user terminal 30 through a wireless network. Further, the communication portion 120 provides information useful to a vehicle rental service, according to the control of the controller 110, or may transmit/receive a control instruction.

The communication portion 120 may receive integrated data for the user through a wireless network from the car-sharing service provider server 21, the insurance company server 22, and the industrial complex server (e.g., the Road Traffic Authority) 23. The communication portion 120 may add benefits or restrictions to the rental service provided to the user based on the safe driving grade determined by the controller 110. The communication portion 120 may receive the user's face image from the user terminal 30 through the wireless network, and may receive the user's sobriety test result from a drink measure means. The user's face image may be generated through a camera provided in the user terminal 30. The sobriety test result may be generated by means of a sobriety test. The sobriety test means may be provided in the vehicle.

The communication portion 120 may transmit a door control signal or a driving control signal for the vehicle to the user terminal 30. The user terminal 30 transmits a door control instruction based on the received door control signal or a drive control instruction based on the received drive control signal to an electronic control unit (ECU) of the vehicle. The ECU may control the door and operation of starting the vehicle based on the control instruction.

The storage portion 130 may store or update the integrated data for the user in the database. The storage portion 130 may store booker information in a database and provide the reservation information to the controller 110 according to a signal of the controller 110.

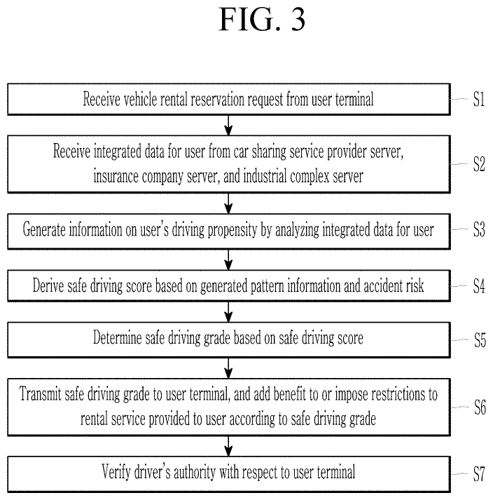

Hereinafter, referring to FIGS. 3 to 5, a vehicle rental method according to an embodiment is described.

FIG. 3 is a flowchart of a vehicle rental method according to an embodiment.

A communication portion 120 may receive a vehicle rental reservation request from a user terminal 30 (S1). The storage portion 130 may store booker information included in the reservation request in the database. Hereinafter, it is explained that a person making the reservation (i.e., a booker) is a user of the user terminal 30.

The communication portion 120 may receive integrated data for a user from a car-sharing service provider server 21, an insurance company server 22, and an industrial complex server 23 (S2).

The integrated data may include driving pattern data, accident history data, law violation data, driver's license data, member authority data, and profile data. The communication portion 120 receives driving pattern data, member authority data, and profile data for the user from the car-sharing service provider server 21. The communication portion 120 also receives accident history data for the user from the insurance company server 22, and receives violation of laws data and driver's license data of the user from the industrial complex server 23.

The controller 110 may generate information about the user's driving propensity by analyzing the integrated data for the user (S3). The information about the user's driving propensity may include pattern information generated by analyzing the user's driving pattern data, evaluation information generated by analyzing the user's member authority data, an accident risk generated by analyzing the user's accident history data and the user's law violation data, and license information generated by analyzing the user's driver's license data.

The pattern information may be generated based on an occurrence frequency of each driving pattern type according to a driving time zone and an occurrence frequency of each driving pattern type according to a road type. The evaluation information may be generated based on: the member status, a member status conversion date, and a reason for the member status conversion. The accident risk may be generated based on an occurrence frequency for each type of accident, the date of the accident, an occurrence frequency for each type of traffic law violation, and the date of violation of the traffic law.

The controller 110 may derive a safe driving score based on the pattern information and the accident risk (S4).

The controller 110 may derive a user's extreme driving score based on the pattern information. The controller 110 may derive the extreme driving score by summing up the frequency of occurrence of the driving pattern type during the user's driving for a certain period or averaging the frequency of occurrence. In this case, the controller 110 may derive the extreme driving score by putting a weight value for each period in the order of the most recent operation to the frequency for each period. For example, the controller 110 averages the frequency of occurrence of overspeed, not securing a safe distance, sudden acceleration, rapid deceleration, sudden stop, and sudden start during the user's last 6 drives. However, the controller 110 may derive the extreme driving score by applying a weight value of 30%, 20%, 20%, 10%, 10%, and 10% from the most recent operation sequentially.

The controller 110 may derive the user's accident risk score based on the accident risk level. The controller 110 may derive the accident risk score by summing up the frequency of occurrence of accident types during the user's certain period of driving or averaging the frequency of occurrence. In this case, the controller 110 may derive the accident risk score by putting the weight value for each period in the order of the most recent operation to the frequency by period. For example, the controller 110 averages the frequency of occurrence of traffic law types and accident types such as speeding, centerline violation, and signal violation during the user's last 6 drives. However, the accident risk score may be derived by applying a weight value of 30%, 20%, 20%, 10%, 10%, and 10% sequentially from the most recent operation.

The controller 110 may derive a safe driving score based on the user's extreme driving score and the user's accident risk score. For example, the controller 110 may derive the average value of the user's extreme driving score and the user's accident risk score as the user's safe driving score.

The controller 110 may determine a safe driving grade based on the safe driving score (S5).

The safe driving grade may include at least one individual grade. The controller 110 may calculate the safe driving score as the first grade when the safe driving score belongs to the first score range, and the second grade when the safe driving score belongs to the second score range. Here, the first score range may be greater than or equal to a reference score, and the second score range may be less than the reference score. The reference score may be predetermined based on initial information.

For example, when the user's safe driving score is 70 or higher, the controller 110 determines the user's safe driving score as a risk customer grade. When the user's safe driving score is less than 70, the controller 110 determines the user's safe driving score as a safe customer grade.

The controller 110 transmits the safe driving grade to the user terminal 30 and may add benefits or restrictions to the rental service provided to the user according to the safe driving grade (S6). Benefits added to the rental service may include a discount on driving fees, improvement of member point accumulation rate, payment of coupons for use, gift-giving, preferential vehicle dispatch, and the like. Restrictions added to the rental service may include limiting the maximum speed of the vehicle, limiting the use time of the vehicle (e.g., prohibition of night driving), limiting the daily operating time of the vehicle, and the like. The driving fee may mean a fee generated according to the use of the vehicle rental service provided by the rental management server.

For example, when the user's safe driving grade is a safety grade, the controller 110 may provide a driving fee discount to the user.

In addition, when the user's safe driving grade is a risk grade, the controller 110 may impose a vehicle's maximum speed limit on the user. In this case, the controller 110 may transmit a control instruction limiting the maximum speed to the user terminal 30. The user terminal 30 transmits a control instruction to control the speed of the vehicle to the ECU, and the ECU may limit the maximum speed of the vehicle according to the control instruction.

The controller 110 transmits a message notifying benefits (e.g., a discount on a driving fare) to the user terminal of the safe grade user together with the user's safe driving grade to the user terminal 30. The controller 110 further transmits a message notifying limits (e.g., a message notifying that the maximum speed is limited) to the user terminal of the user.

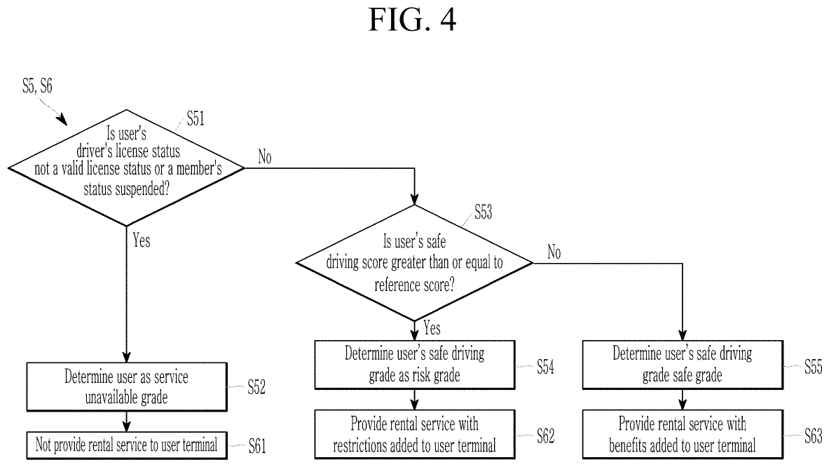

When determining the safe driving grade of the user, the controller 110 may perform the steps shown in FIG. 4 in adding a benefit to the user terminal according to the safe driving grade or providing a rental service with restrictions added.

FIG. 4 is a detailed flowchart of step S5 and step S6 in FIG. 3.

The controller 110 determines the user's safe driving grade based on the user's driving propensity information generated in S3. According to the safe driving grade, the controller 110 further determines to add benefits or impose restrictions to the rental service to be provided to the user terminal 30.

The controller 110 may determine whether to classify the user into a service unavailable grade based on the evaluation information and the license information. The controller 110 may determine whether the user's driver's license status is not a valid license status or a member's status is suspended (S51).

As a result of the determination in S51, when the driver's license status of the user is not a valid license status or the membership is suspended, the controller 110 may determine the user as a service unavailable grade (S52).

When the user is determined to be a service unavailable grade in S52, the controller 110 may not provide a rental service to the user terminal 30 (S61).

As a result of the determination in S51, when the user's driver's license status is not a valid license status or does not correspond to a suspended membership (i.e., when the driver's license status is a valid license and not a suspended membership), the controller 110 may determine whether the user's safe driving score is greater than or equal to the reference score (S53).

When a result of step S51 is determined to be that the user's driver's license status is not a valid license or does not correspond to a suspended membership, the storage portion 130 updates the extreme driving score and updates the accident risk score derived in S4 to the database. The controller 110 may determine the safe driving grade of the user by comparing the safe driving score, and the reference score derived in step S4. As a result of the determination in S53, when the user's safe driving score is greater than or equal to the reference score, the controller 110 may determine the user's safe driving grade as the risk grade (S54).

When the user is determined to be the risk grade in S54, the controller 110 may provide a rental service with restrictions added to the user terminal 30 through the communication portion 120 (S62).

As a result of the determination in S53, when the user's safe driving score is less than the reference score, the controller 110 may determine the user's safe driving grade as the safety grade (S55).

When the user is determined to have the safety grade in S55, the controller 110 may provide a rental service with added benefits to the user terminal 30 through the communication portion 120 (S63).

The controller 110 may verify the driver's authority with respect to the user terminal 30 (S7).

The driver authority may include the door control authority of the vehicle and the driving control authority of the vehicle, that the controller 110 grants to the user terminal 30, such that the user drives (e.g. gains control of) the vehicle. The door control authority may be the authority for the user to control whether the vehicle's door is locked/unlocked through the user terminal 30. The driving control authority is the authority for the user to start and drive the vehicle through the user terminal 30.

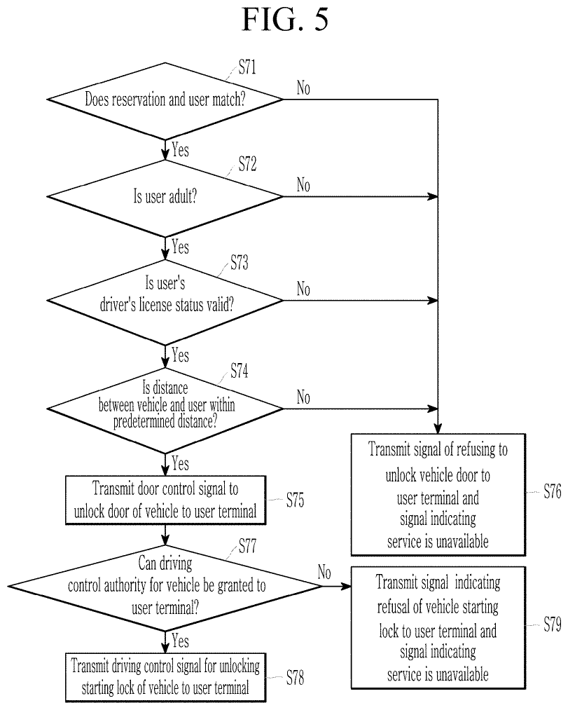

The controller 110 verifies the user's driver authority for the user terminal 30, and the steps shown in FIG. 5 may be performed.

FIG. 5 is a detailed flowchart of step S7 in FIG. 3.

The controller 110 may determine whether to transmit a door control signal or a driving control signal for the vehicle to the user terminal 30 by comparing the booker information and the user's biometric information and sobriety test result on the reservation request stored in the database.

The communication portion 120 may transmit a door control signal to unlock the door of the vehicle to the user terminal 30 (S75) when the booker and the user match (S71), the user is an adult (S72), the user's driver's license status is valid (S73), and a distance between the vehicle and the user is within a predetermined distance (S74).

In S71, the controller 110 may determine whether or not the booker information included in the reservation request matches the profile data among the integrated data for the user. In addition, the controller 110 may perform an additional identity authentication procedure through the user terminal 30 for identity verification.

In S72, the controller 110 may determine whether the user is an adult based on the profile data among the integrated data for the user. In addition, the controller 110 may perform an additional adult authentication procedure through the user terminal 30 to determine whether the user is an adult. Alternatively, when the user is authenticated, according to the additional identity authentication procedure in S71, the controller 110 may determine whether the user is an adult based on the identity authentication result in S72.

In S74, the controller 110 may determine whether the position of the user is within a predetermined distance by comparing the position of the vehicle based on a Global Positioning System (GPS) of the vehicle and the position of the user based on the GPS of the user terminal.

The user terminal 30 may transmit a door control instruction based on the received door control signal to the ECU of the vehicle, and the ECU may control the door of the vehicle based on the control instruction.

In addition, the communication portion 120 may transmit a signal refusing to unlock the vehicle door to the user terminal 30 and a signal indicating that the service is unavailable (S76) when: the booker and the user do not match in S71, the user is determined to be a minor in S72, the driver's license status of the user is not a valid license status in S73, or the distance between the vehicle and the user exceeds a predetermined distance in S74.

The controller 110 may determine whether to grant the driving control authority for the vehicle to the user terminal 30 based on the user's biometric authentication information and the breath measurement result (S77).

The user may take a face image of the user through the camera provided in the user terminal 30. The controller 110 may determine whether the user is a registered user by comparing the facial image of the user received from the user terminal 30 with the biometric authentication information included in the profile data among the integrated data for the user. The controller 110 may apply a biometric authentication algorithm to determine whether the facial image is included in the registered user information. The registered user information may include a facial image of a user registered as a driver capable of driving the vehicle 20 in the rental management server 10.

The user may measure the user's drinking through a sobriety test means provided in the vehicle. The sobriety test means may generate the user's sobriety test result and transmit it to the rental management server 10 through the user terminal 30, or directly transmit the sobriety test result to the rental management server 10. The controller 110 may determine whether the user drinks alcohol based on the sobriety test result.

The storage portion 130 may store the facial image and sobriety test result of the user received from the user terminal 30 in the database.

When it is determined that the user is a registered user based on the facial recognition result and the user does not drink, the controller 110 may grant driving control authority for the vehicle to the user terminal 30.

In S77, when the driving control authority may be granted, the controller 110 may transmit a driving control signal for unlocking the starting lock of the vehicle to the user terminal 30 (S78).

The user terminal 30 that has received the driving control signal may release the vehicle starting lock by transmitting the signal to the vehicle.

The user terminal 30 may transmit a driving control instruction based on the received driving control signal to the ECU of the vehicle, and the ECU may control driving of the vehicle based on the control instruction. When the lock for starting the vehicle is released, the user may start the vehicle and drive.

In S77, when the driving control authority cannot be granted, the communication portion 120 may transmit a signal indicating that the vehicle starting lock is rejected to the user terminal 30 and a signal indicating that the service is unavailable (S79).

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### Description of Symbols

1: vehicle rental system

10; rental management server

21: car sharing service provider server

22: insurance company server

23: industrial complex server

30: user terminal

31: application

110: controller

120: communication portion

130: storage portion

What is claimed is:

1. A rental management server comprising:
a communication portion configured to: receive a rental reservation request for a vehicle from a user terminal, and receive an integrated data about a user, wherein the integrated data comprises at least three of driving pattern data, accident history data, traffic law violation data, license data of a driver, member authority data, and profile data from an external server;
a controller configured to:
generate information on a driving propensity of the user by analyzing the integrated data,
derive a safe driving score for the user based on information about driving propensity of the user,
determine a safe driving grade for the user based on the safe driving score, and
add benefits or restrictions to rental services provided to the user according to the safe driving grade; and
a storage portion configured to store booker information included in the reservation request and the integrated data in a database,
wherein the information about the driving propensity includes pattern information generated by analyzing the driving pattern data, and an accident risk generated by analyzing the accident history data.

2. The rental management server of claim 1, wherein
the controller is configured to derive an extreme driving score of the user according to a frequency of occurrence of a driving pattern type based on the pattern information, and
an accident risk score of the user is derived according to an accident type.

3. The rental management server of claim 2, wherein
the controller is configured to derive a safe driving score for the user based on the extreme driving score and the accident risk score.

4. The rental management server of claim 1, wherein
the controller is configured to impose a maximum speed limit on a rental service provided to the user when the safe driving grade is a risk grade.

5. The rental management server of claim 1, wherein
the controller is configured to add a service usage fee discount to the rental service provided to the user when the safe driving grade is a safe grade.

6. The rental management server of claim 1, wherein
the controller is configured to transmit a door control signal to unlock the door of the vehicle to the user terminal when the booker and the user match, the user is an adult, a license status of the driver included in the license data is valid, and a distance between a position of the vehicle and the user is within a predetermined distance.

7. The rental management server of claim 6, wherein
after transmitting the door control signal, when the controller is able to impose a driving control authority with respect to the vehicle to the user terminal based on a face image and a sobriety test result of the user, the controller is configured to transmit a driving control signal to unlock a starting lock of the vehicle to the user terminal.

8. A vehicle rental method comprising:
receiving a rental reservation request for a vehicle from a user terminal by a rental management server;
receiving an integrated data about a user from an external server by the rental management server, wherein the integrated data includes at least three of driving pattern data, accident history data, traffic law violation data, license data of a driver, member authority data, and profile data;
generating a driving propensity of the user by analyzing the integrated data by the rental management server;
determining a safe driving score of the user and a safe driving grade of the user by analyzing information on the driving propensity by the rental management server, wherein the information on the driving propensity includes pattern information generated by analyzing the driving pattern data, and an accident risk generated by analyzing the traffic law violation data; and
providing a rental service to which benefits or restrictions are added to the user according to the safe driving grade by the rental management server.

9. The vehicle rental method of claim 8, further comprising:
when the safe driving grade is a risk grade, imposing a maximum speed limit on the rental service provided to the user terminal by the rental management server; and
when the safe driving grade is a safe grade, adding a service usage fee discount to the rental service provided to the user terminal by the rental management server.

10. The vehicle rental method of claim 8, further comprising:
verifying a driver's authority with respect to the user terminal by the rental management server.

11. The vehicle rental method of claim 10, further comprising:
transmitting a door control signal to unlock a door of the vehicle to the user terminal by the rental management server when a booker included in the reservation request matches the user, the user is an adult, the user's driver's license status included in the driving license data is valid, and a distance between the position of the vehicle and the user is within a predetermined distance.

12. The vehicle rental method of claim 11, further comprising:
transmitting a signal indicating that the service is unavailable to the user terminal by the rental management server when the booker included in the reservation request does not match the user, the user is not an adult, the driver's license status of the user included in the driving license data is not a valid license status, or the distance between the vehicle and the user exceeds the predetermined distance.

13. The vehicle rental method of claim 11, further comprising:
after transmitting the door control signal, transmitting a driving control signal to unlock a starting lock of the vehicle to the user terminal by the rental management server when driving control authority with respect to the vehicle is imposed to the user terminal.

14. The vehicle rental method of claim 13, further comprising:
transmitting the driving control signal to the user terminal by the rental management server when the user corresponds to a registered user based on a face image of the user and when the user is determined to be sober based on a sobriety test result of the user.
